(19) United States
(12) Patent Application Publication
(10) Pub. No.: US 2010/0028764 A1
(43) Pub. Date: Feb. 4, 2010

(54) MODULAR BATTERY UNIT

(75) Inventors: Günter Maier, Graz (AT); Martin Michelitsch, Weiz (AT)

Correspondence Address: BACHMAN & LAPOINTE, P.C., 900 CHAPEL STREET, SUITE 1201, NEW HAVEN, CT, 06510, US

(73) Assignee: MAGNA STEYR FAHRZEUGTECHNIK AG & CO. KG, Graz (AT)

(21) Appl. No.: 12/441,682

(22) PCT Filed: Sep. 18, 2007
(86) PCT No.: PCT/EP07/08117

§ 371 Date: Mar. 17, 2009

(30) Foreign Application Priority Data
Sep. 18, 2006 (AT) GM 679/2006
Sep. 14, 2007 (DE) 10 2007 043 947.6

(51) Int. Cl. H01M 10/50; B23P 15/26

(52) U.S. Cl. 429/120; 29/890.035

(57) ABSTRACT

A modular battery unit with at least two battery cells (1-6) and a heat sink (8), which is arranged between the battery cells (1-6), conforms laterally to the battery cells, has a cooling medium flowing through it and, on the one hand, transports heat which has developed in the battery cells away in a suitable manner and, on the other hand, supports the battery cells, and with two covering caps (11, 12), which can be arranged on the heat sink, wherein a first one of the two covering caps (11) is provided for closing the first end face of the heat sink and a second one of the two covering caps (12) is provided for closing the second end face of the heat sink and an inlet (16) and an outlet (17) for the cooling medium are provided, and wherein the inlet and/or the outlet of the cooling medium is arranged at the first covering cap (11) or the second covering cap (12).

### BACKGROUND OF THE INVENTION

The invention relates to a modular battery unit having at least two battery cells and a suitable heat sink, to a battery system formed from a plurality of modular battery units, and to a method for adapting a battery system to an installation space, in particular of a vehicle.

One refinement of such a battery unit is disclosed in EP 0917230 B1, in which round cells are surrounded by a suitable heat-treatment device.

EP 1508182 B1 discloses an alternative refinement of a battery having a plurality of memory cells.

The object of the invention is to develop a modular battery unit which is distinguished by a simple design and optimum adaptation to an existing installation space, in particular of a motor vehicle, as well as cooling which is as efficient as possible.

### SUMMARY OF THE INVENTION

The battery unit should be designed in such a manner that it can be produced as simply and cost-effectively as possible with a variable arrangement of the cells and ensures a temperature distribution which is as uniform as possible for all cells. This is achieved by means of a battery unit having a modular battery unit comprising at least two battery cells and a heat sink arranged between the battery cells and nestles laterally against the battery cells, the heat sink has a cooling medium flowing through it and, on the one hand, removes heat produced in the battery cells in a suitable manner and, on the other hand, supports the battery cells, two covering caps are arranged on the heat sink, a first of the two covering caps closes a first end face of the heat sink and a second of the two covering caps closes a second end face of the heat sink, an inlet and an outlet for the cooling medium for the heat sink, the inlet for the cooling medium being arranged on one of the first and second covering cap and the outlet for the cooling medium being arranged on either of the first and second covering cap.

One embodiment of the apparatus according to the invention provides a modular battery unit having at least two battery cells and a heat sink, which is arranged between the battery cells, nestles laterally against the battery cells, has a cooling medium flowing through it and, on the one hand, removes heat produced in the battery cells in a suitable manner and, on the other hand, supports the battery cells. Two covering caps which can be arranged on the heat sink are also provided, a first of the two covering caps being intended to close the first end face of the heat sink and a second of the two covering caps being intended to close the second end face of the heat sink, and an inlet and an outlet for the cooling medium being provided, the inlet and/or outlet for the cooling medium being arranged on the first covering cap or the second covering cap.

According to one preferred embodiment of the apparatus according to the invention, the covering cap is in the form of a covering plate. In addition, any other desired forms of the covering caps may be used as long as they can be used to close the cooling channels of the heat sink in a suitable manner.

According to one preferred embodiment of the apparatus according to the invention, the longitudinal direction of the heat sink is defined as the direction of its greatest extent. According to a special design of the apparatus according to the invention, the channels of the heat sink are likewise oriented in the longitudinal direction.

According to another embodiment of the apparatus according to the invention, the inlet for the cooling medium is arranged on the first covering cap and the outlet for the cooling medium is arranged on the second covering cap.

According to another embodiment of the apparatus according to the invention, both the outlet and the inlet for the cooling medium are arranged on the first covering cap.

According to another embodiment of the apparatus according to the invention, the heat sink has separate channels running in the longitudinal direction of the heat sink between the first and second covering caps, the cooling medium flowing through adjacent channels in opposite directions.

According to another embodiment of the apparatus according to the invention, the heat sink has separate channels running in the longitudinal direction of the heat sink between the first and second covering caps, the cooling medium flowing through adjacent channels in the same direction.

According to another embodiment of the apparatus according to the invention, the heat sink has separate channels running in the longitudinal direction of the heat sink between the first and second covering caps, the cooling medium flowing in adjacent channels in a first direction in a first region of the heat sink and flowing in adjacent channels in a second direction, which is opposite the first direction, in a second region.

According to another embodiment of the apparatus according to the invention, a plurality of battery cells are arranged behind one another in the longitudinal direction of the heat sink.

According to another embodiment of the apparatus according to the invention, at least one of the covering caps, in particular both covering caps, is/are in the form of die-cast parts and is/are fastened to the heat sink in a suitable manner, in particular is/are welded to the heat sink.

According to another embodiment of the apparatus according to the invention, the heat sink is an extruded part, the channels in the interior of the heat sink being formed by corresponding walls of the extruded profile.

According to another embodiment of the apparatus according to the invention, the connection between two adjacent channels is produced by notches in the walls, which notches alternately start from the two end faces of the heat sink.

According to another embodiment of the apparatus according to the invention, the walls of the extruded profile, which are tubular in particular, are scaled back in the longitudinal direction of the heat sink in order to connect two adjacent channels of the heat sink.

According to another embodiment of the apparatus according to the invention, the heat sink has recesses in the shape of an arc of a circle for accommodating the battery cells back to back and side by side, a first profile part which forms a tube and from which intermediate walls start in a star-shaped manner being provided between four respective recesses.

According to a special embodiment of the apparatus according to the invention, at least one of the battery cells is pressed and/or adhesively bonded onto the heat sink. This makes it possible to ensure good heat transfer between the battery cell and the heat sink.

According to another embodiment of the apparatus according to the invention, the covering caps each have a hole in a manner which is congruent with the profile part which forms a tube, with the result that the two covering caps can be connected to one another by means of first pulling elements.

According to another embodiment of the apparatus according to the invention, the extruded profile which forms the heat sink has recesses in the shape of an arc of a circle for accommodating the cells back to back and side by side, a second profile part which forms a tube and forms three intermediate walls being provided between the two uppermost and lowermost recesses, which are arranged back to back, and a transverse part of the profile.

According to another embodiment of the apparatus according to the invention, the second profile parts which form a tube are flow-connected, on one side, to the inlet or outlet for the coolant.

According to another embodiment of the apparatus according to the invention, an enclosure for the battery cells and the heat sink is provided. The enclosure is formed by outer pulling elements which surround the battery cells on their outer side facing away from the heat sink. According to a special embodiment, the space between the outer pulling elements and those parts of the cells which do not rest on the heat sink is filled by a triangular longitudinal profile.

According to another embodiment of the apparatus according to the invention, the triangular longitudinal profile is hollow.

According to another embodiment, the invention is characterized by a battery system having a plurality of modular battery units as claimed in one of claims 1 to 17, the modular battery units being arranged adjacent to one another in a suitable manner in a housing, and the inlets and outlets respectively being connected to one another.

According to another embodiment of the battery system according to the invention, each heat sink has a vertical center plane oriented along the longitudinal direction of the heat sink, the battery units being laterally arranged behind one another in a direction normal to the vertical center planes of the heat sinks.

According to another embodiment, the invention is characterized by a method for adapting a battery system to an installation space, in particular of a vehicle, the battery system being formed from at least one modular battery unit as claimed in one of claims 1 to 17, and the heat sink of the modular battery unit having a predefined width and height and a variable length, the length of the heat sink being selected in a manner corresponding to an installation space length available in the installation space.

According to another embodiment of the method according to the invention, the heat sink of the modular battery unit is tailored to the selected length from an extruded profile.

According to one embodiment of the invention, the heat sink of the battery unit is produced by means of extrusion.

According to a special embodiment of the invention, the heat sink or the carrier plate is in the form of an extruded part made of light metal, the profile of the extruded part having channels in its interior which are separated by intermediate walls and run in the longitudinal direction of the extruded part, the liquid in adjacent channels flowing in opposite directions, and the extruded profile which forms the carrier plate being respectively closed at its two end faces by a covering plate.

According to a special embodiment of the invention, the production of profiles by means of extrusion, which is known per se, is used to form a plurality of parallel cooling channels having a largely constant wall thickness with respect to the surface of the recesses and adjacent cooling channels with a direction of flow which is, in particular, opposite. A more uniform temperature distribution is thus achieved in each direction. The end plates or covering caps which close the cooling channels, which are naturally open on both sides of the extruded profile, form connections for the cooling liquid, with the result that the extruded profile itself is used with a minimum amount of machining.

In addition, because they can be cut to any desired length, extruded profiles afford the advantage in this application that a different number of cells can be arranged behind one another in a recess. As a result, the dimensions of a battery can be adapted to the respective installation space available. This also allows the extruded profile which forms the carrier plate to be closed at its two end faces with a standard covering plate which corresponds to the profile.

According to a special embodiment of the invention, the channels are connected by means of milled-in formations in the covering plate. However, in one preferred design, said connections are produced by notches in the intermediate walls, which notches start from the respective end face, with the result that the covering plates do not need to be machined specifically for this purpose and may be structurally identical. Instead of the notches, the tubular wall parts with the inlet or outlet may be scaled back in the longitudinal direction.

According to a special embodiment of the invention, the outer contour of the extruded profile which forms the carrier plate forms the recesses in the shape of an arc of a circle for accommodating the cells in at least two parallel rows, with the result that the recesses for the cells are pairs of recesses which are back to back and pairs of recesses which are side by side. In one preferred design, a first profile part which forms a tube and from which the intermediate walls start in a star-shaped manner is provided between four respective recesses. As a result of these profile parts at the locations at which the carrier plates are widest, an area through which there is no flow and, around said area, channels of approximately the same cross section for the cooling flow are thus created. As a result, the flow velocity which is decisive for heat transfer remains largely unchanged. In one development, the covering plates each have a hole which is congruent with the respective profile part, which forms a tube, and through which the two covering plates are also held together in their central region by means of first pulling elements. The pulling elements are preferably bolts which press the covering plates onto the carrier plate with sealing.

In a similar manner, according to another preferred embodiment, a second profile part which forms a tube and itself forms three intermediate walls may be respectively provided between the two uppermost and lowermost recesses in a row, which are arranged back to back, and a transverse part of the profile. These profile parts are connected, on one side, to the liquid cooling circuit. Their other end is closed in a liquid-tight manner. For this purpose, the covering plates have openings, through which the cooling liquid is supplied and discharged, on the side on which they are connected to the cooling circuit.

In one development of the battery unit according to another preferred embodiment, the outer enclosure of the battery unit is formed by outer pulling elements which surround the cells on their side facing away from the carrier plate, the space between the second pulling elements and those parts of the cells which do not rest on the carrier plate being filled, if necessary, by a triangular longitudinal profile. This ensures that all cells rest on the recesses of the carrier plate. According to another preferred embodiment, these are hollow triangular profiles. If the cooling liquid likewise flows through the latter, the temperature distribution is also improved on the circumference of the cells.

### BRIEF DESCRIPTION OF THE DRAWINGS

The invention is described and explained below using exemplary and non-restrictive Figures, in which:

FIG. 1: shows an axonometric view of a battery according to the invention,

FIG. 2: shows the same as FIG. 1 but without a cover,

FIG. 3: shows an end view according to A in FIG. 2,

FIG. 4: shows an end view according to B in FIG. 2,

FIG. 5: shows a longitudinal section according to V-V in FIG. 3 and FIG. 4,

FIG. 6: shows another possible embodiment of a battery unit according to the invention,

FIG. 7: shows a longitudinal section of the heat sink from FIG. 6,

FIG. 8: shows a battery system composed of a plurality of battery units according to FIG. 6,

FIG. 9: shows different possible embodiments of battery units, and

FIG. 10: shows an alternative design of a heat sink.

### DETAILED DESCRIPTION

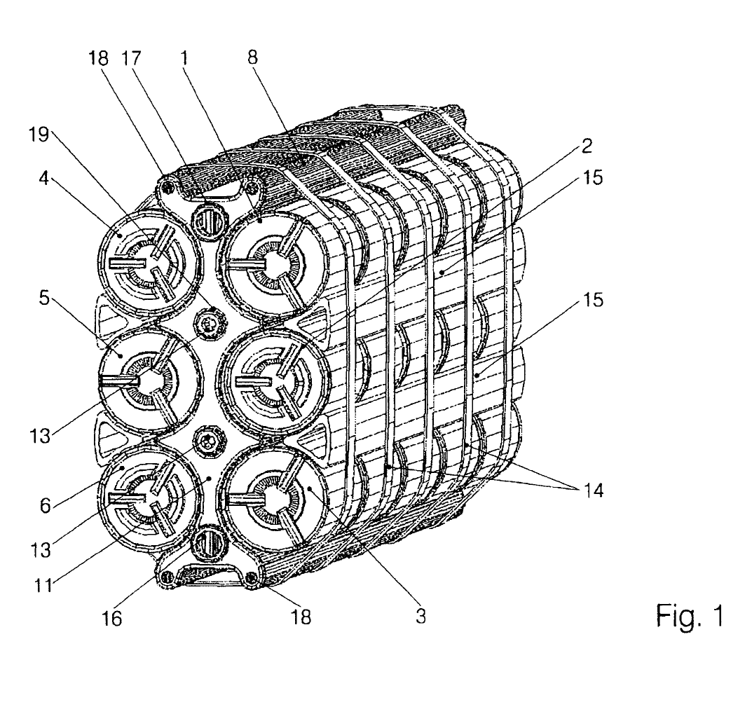

In FIG. 1, the cells which are arranged in two parallel rows are provided with the reference symbols 1 to 6; the cells 1 to 3 form a first row and the cells 4 to 6 form a second row. The cells may be high-power cells of any desired design and chemical method of operation. They are cylindrical and either extend over the entire length of the battery or are composed of five individual cells which are arranged behind one another as in the exemplary embodiment shown. There is no need to discuss the electrical connections and terminals because they are not important for the invention. A heat sink 8 or carrier plate through which the coolant flows in a manner which is yet to be described extends over the entire length between two rows of cells. Said heat sink or carrier plate is an extruded profile preferably made of light metal or made of another suitable material. Producing the heat sink by means of extrusion allows a hollow body which is open on both sides and has a complex cross section to be produced with little production complexity. A profile which has been produced in this manner and has been cut into pieces having the length of the battery unit is closed, at its two end faces 9, 10 formed in this manner, with a cover or covering cap 11 or 12 (see FIG. 5). The covering caps 11, 12 may also be designed such that they hold and/or fix the cells 1 to 6, in particular in their longitudinal direction.

The two covering caps 11, 12 are held together by first pulling elements 13 (for example long threaded bolts). For this purpose, the covers 11, 12 are provided with holes 18 on the edge and holes 19 in the central region of the carrier plate 8. All of the cells 1 to 6 of the battery are pressed onto the heat sink 8 and held together by second or outer pulling elements 14, tightening straps in this case. An approximately triangular hollow longitudinal profile 15 is respectively fitted between the second or outer pulling elements 14 and that contour of the cells 1 to 6 which faces away from the carrier plate 8. Approximately because two sides form concave cylinder faces which rest on two respective cells. Holes 16, 17 for connection to the cooling circuit are also provided in the front covering cap 11, the lower hole (16) for the inlet and the upper hole (17) for the outlet.

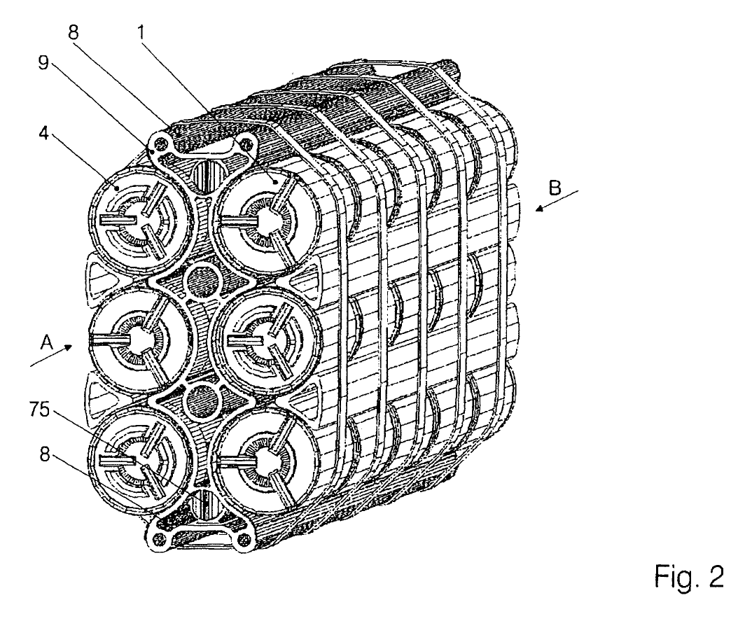

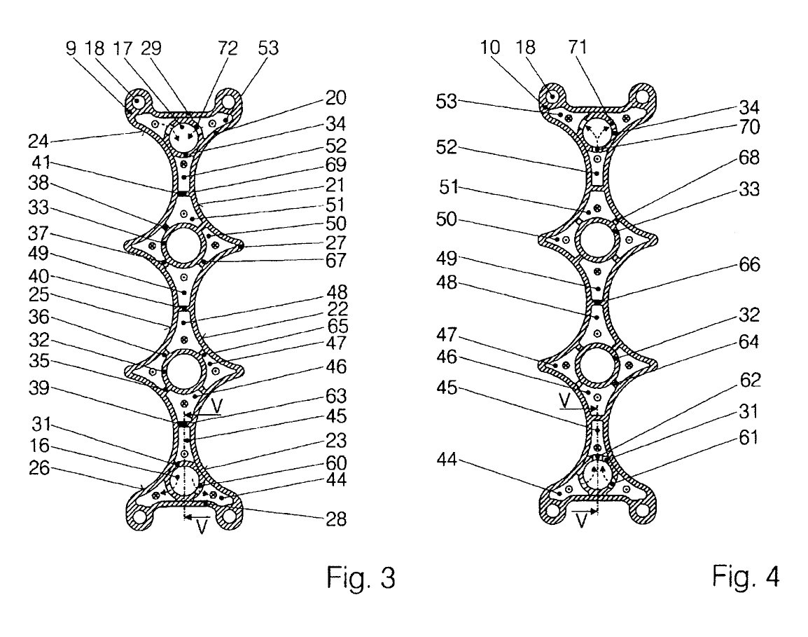

FIG. 2 shows the same battery with the front covering cap 11 removed, with the result that the end face 9 of the extruded profile and thus its cross section are presented to the viewer. It can be seen on an enlarged scale and without the cells in FIG. 3.

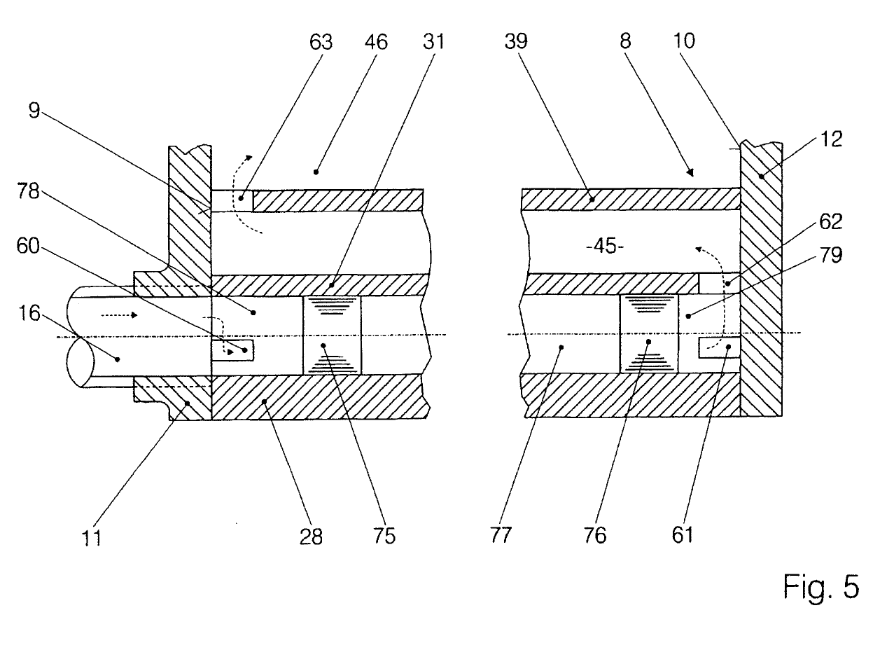

FIG. 3 illustrates the front end face 9 and FIG. 4 illustrates the rear end face 10 of the extruded profile alone. The outer wall of the extruded profile, which is denoted overall by 20, forms recesses 21 to 26 in the shape of an arc of a circle for the cells 1 to 6 which are thus arranged in pairs back to back and beside one another. In addition, the outer wall 20 forms a lower (28) transverse wall and an upper (29) transverse wall. Holes 18 for further first pulling elements are made at the junction between the recesses and the transverse walls 28, 29.

A number of channels (44-53) running in the longitudinal direction are formed inside this outer wall 20 by means of different walls. A first tubular profile part 31 which touches the three outer wall parts and, to a certain extent, forms an inscribed circle is thus formed between the lower transverse wall 28 and the parts which form the recesses 23, 26. The same first tubular profile part is arranged between the upper transverse wall 29 and those parts of the outer wall 20 which form the recesses 21, 24.

A second tubular profile part 33 is formed at the widest point at the level of the ridges 27 between the wall parts which in this case form the recesses 21, 22, 25 and 24. Intermediate walls 37, 38 start from said second profile part in a star-shaped manner and lead to the outer wall parts which form the recesses. In the same manner, a second tubular profile part 32 having the intermediate walls 35, 36 is formed between the recesses 22, 23, 25, 26. Partition walls 39, 40, 41 are approximately at the narrowest points of the extruded profile.

These intermediate walls 35-38 and partition walls 39-41 form flow channels which are separated from one another and in which the direction of flow alternates between adjacent flow channels according to one exemplary embodiment. The directions of flow are indicated in the usual manner in FIG. 3: a circle with a dot represents an arrow directed toward the viewer's eye, a circle with a cross represents an arrow going away from the viewer. In FIG. 4 which shows the rear end face 10, the symbols for the direction of flow for the same channel are opposite those in FIG. 3.

The following channels are formed in this manner: two symmetrical first channels 44 through which a flow passes toward the rear end face 10; a second channel 45 through which a flow passes to the front end face 9; a third channel 46 through which a flow passes to the rear end face 10; two symmetrical fourth channels 47 through which a flow passes to the front end face 9; a fifth channel 48 through which a flow passes to the rear end face 10; a sixth channel 49 through which a flow passes to the front end face 9; two symmetrical seventh channels 50 through which a flow passes to the rear end face 10; an eighth channel 51 through which a flow passes to the front end face 9; a ninth channel 52 through which a flow passes to the rear end face 10; and two symmetrical tenth channels 53 through which a flow passes to the front end face 9.

In order to divert the flow at the end faces, corresponding diverting channels may be milled into the inside of the covering caps 11, 12. However, according to the invention, they are produced by notches in the intermediate walls and partition walls of the extruded profile 8, which notches start from the end faces 9, 10. Since all of these notches start from one of the two end faces 9, 10, they can be made with little production complexity, for instance by means of milling.

In FIG. 3, the notches which start from the front end face 9 are provided with the following reference symbols: 60 in the tubular profile part 31 for connecting the inlet 16 to the first channels 44; 63 in the partition wall 39 for connecting the second channel 45 to the third channel 46; 65 in the intermediate walls 35 for connecting the two fourth channels 47 to the fifth channel 48; 67 in the intermediate walls 37 for connecting the sixth channel 49 to the two seventh channels 50; 69 in the partition wall 41 for connecting the eighth channel 51 to the ninth channel 52; 72 for connecting the two tenth channels 53 to the outlet 17. Instead of the notches 60, 62, 70, 71, the tubular wall parts 31, 34 may be scaled back in the longitudinal direction.

FIG. 4 shows the notches in the rear end face 10: 61 and 62 for connecting the two first channels 44 to the second channel 45; 64 in the intermediate walls 35 for connecting the third channel to the two fourth channels 47; 66 in the partition wall 40 for connecting the fifth channel 48 to the sixth channel 49; 68 in the intermediate walls 38 for connecting the seventh channels 50 to the eighth channel 51; 70 and 71 in the tubular profile part 34 for connecting the ninth channel 52 to the two tenth channels 53.

The notches in the first tubular profile parts 31, 34 result in a special feature which can be explained using FIG. 5.

It can be seen in FIG. 5 that the first tubular profile part 31 which is connected to the inlet 16 for the coolant contains a respective plug 75, 76 in the vicinity of the front cover 11 and in the vicinity of the rear covering cap 12. These plugs 45, 46 separate an inlet space 78 on one side and a passage space 79 on the other side from a closed space 77, through which no flow passes, between the two plugs 75, 76. The cooling liquid entering through the inlet 16 thus flows into the inlet space 78 and flows from the latter, through the notches 60 (see FIG. 3) into the two first channels 44 which are situated in front of and behind the image area in FIG. 5 and are situated on both sides of the first tubular profile part in FIG. 3. At the other end of the first channels 44, the cooling medium enters the passage space 79 through the notches 61 and enters the second channel 45 from the passage space via the notch 62. At the front end face 9, the cooling medium then flows into the third channel 46 through the notch 63, and so on.

The flow in the first tubular profile part 34 is guided to the outlet 17 in a similar manner but in the opposite direction.

An exemplary embodiment has been described up to now. Unlike this exemplary embodiment, the cells may also be arranged in more than two rows and/or offset with respect to one another and the carrier plate may be correspondingly shaped differently within the scope of the invention. With a suitable arrangement of the inner walls, it is then also possible for the directions of flow to be opposite one another in adjacent channels. As a result, a uniform temperature distribution is achieved on the surface of the carrier plate with production which is very simple and inexpensive.

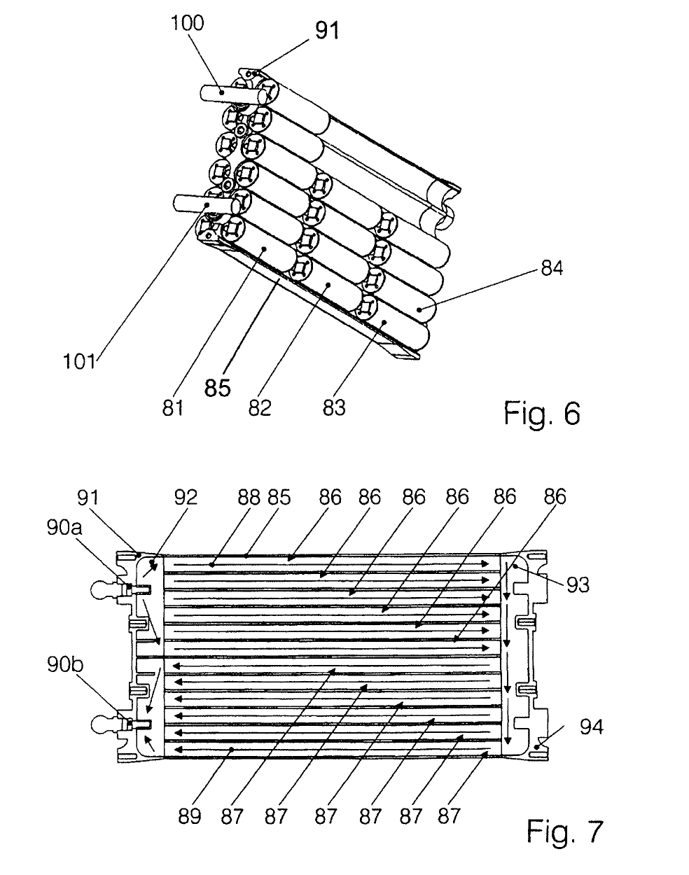

FIG. 6 shows another possible embodiment of a modular battery unit 80 according to the invention. In this case, a plurality of battery cells 81, 82, 83, 84 are arranged on a heat sink 85. In this case, the battery cells are adhesively bonded or pressed onto the heat sink 85 or are brought into contact with the latter in another manner, with the result that heat produced by the battery cells during operation can be transferred to the heat sink 85. As can be seen in FIG. 6, a plurality of battery cells 81, 82, 83 may be arranged on the heat sink 85 behind one another along the longitudinal side of the latter. This is particularly advantageous in the situation in which the heat sink is formed, for example, from an extruded profile and its length can be adapted to the available installation space. The extruded profile can thus be tailored to the required length. Since battery cells are usually available only in standard sizes, a plurality of shorter battery cells are thus arranged behind one another in order to make the best possible use of the full length of the heat sink or the available installation space.

FIG. 7 illustrates a vertical longitudinal section through the heat sink 85 along a center plane. The channels 86, 87 formed in the heat sink 85 can be seen therein. The directions of flow of the cooling medium in the channels 86, 87 are also indicated in the schematic illustration in FIG. 7 by means of corresponding arrows 88, 89. It can be seen in this case that the cooling medium supplied to the covering cap 91 via an inlet 90a in a first, upper region is distributed in a divided distributor space 92 in the covering cap 91 before it is passed to the opposite side of the heat sink 85 to a delimited distributor space 93 of the second covering cap 94 via the channels 86, 87 of the heat sink 85. From this distributor space 93, the cooling medium is then passed again to the opposite side to a collection space or distributor space 94 of the first covering cap 91. From this collection space 94, the cooling medium is discharged from the battery unit via an outlet 90b which is arranged in or on the covering cap 91. The heat sink is thus divided vertically in two, as a result of which a cooling medium flows from a first to a second side in a first, upper region and cooling medium flows back from the second to the first side in a second, lower region.

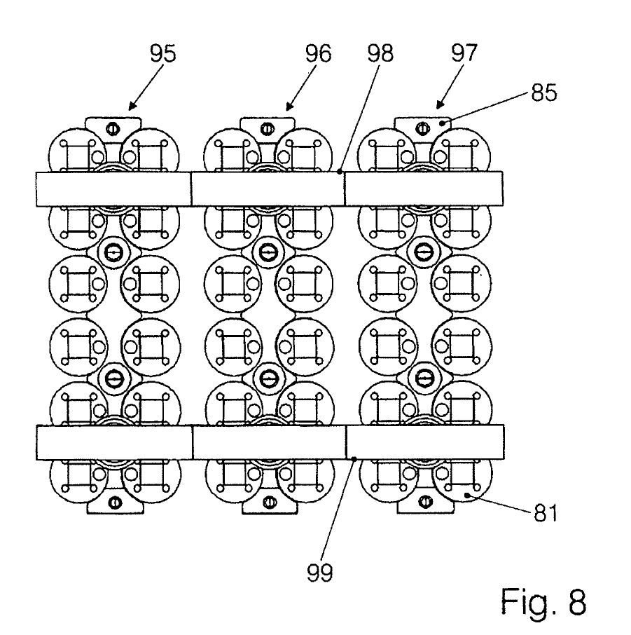

In FIG. 8, a plurality of modular battery units 95, 96, 97 have been combined to form a battery system. For this purpose, the inlets and outlets are connected to one another by means of suitable distributor strips 98, 99 which preferably have integrated seals, for example O-rings. As can be seen from FIG. 8, an upper distributor strip 98 is intended to connect the inlets and a lower distributor strip 99 is intended to connect the outlets. In another embodiment, the positions of the inlets and outlets can of course be interchanged. Each battery unit preferably already has parts of the distributor strips 98, 99 and, as schematically illustrated in FIG. 6, is therefore provided with a first distributor strip element 100 and a second distributor strip element 101 on its covering cap 91, as a result of which the distributor strips can essentially be formed by plugging together the distributor strip elements of the battery units.

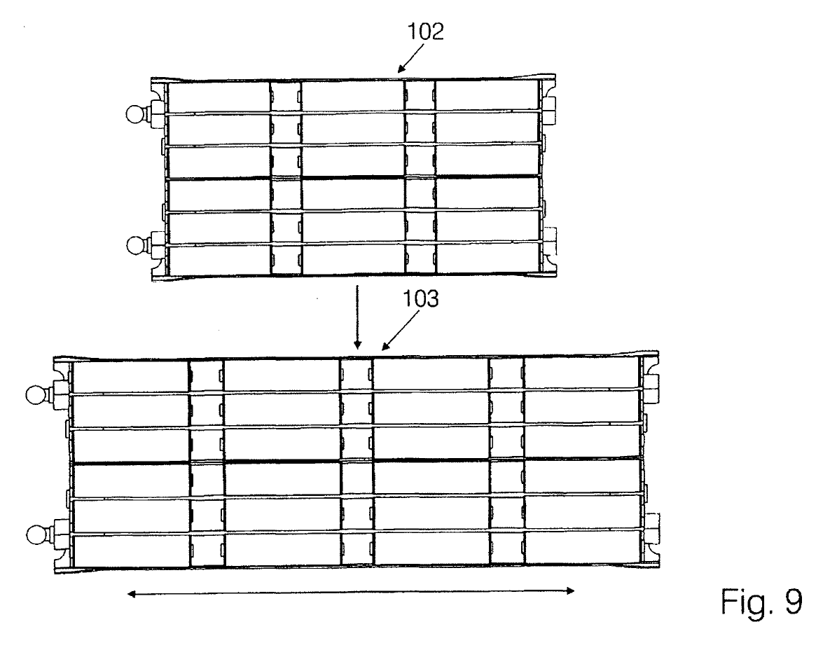

One particular advantage of the inventive design of the modular battery unit is that it is easily adapted to the available installation space. Since the heat sink is generally produced from an extruded profile, the latter can be tailored or adapted to virtually any desired length. Battery units 102, 103 of any desired length can therefore be produced depending on the installation space, as illustrated in simplified fashion in FIG. 9. Depending on the length of the heat sink, suitable battery cells are used or a plurality of battery cells are arranged behind one another in order to use the full length of the heat sink as far as possible. In this respect, the upper region of FIG. 9 illustrates a first design of a battery unit in which 3 rows of battery cells are arranged behind one another on the heat sink, whereas, in the lower region in a second design, 4 rows of vertically arranged battery cells are arranged behind one another on the heat sink. As can be seen, although the lengths of the two embodiments and the lengths of their heat sinks differ, the profile of the heat sink is identical, in particular is produced from a single extruded profile. The battery cells used do not differ either in the two embodiments.

According to another preferred embodiment of the invention, the battery units are arranged behind one another and, if necessary, are connected by their inlets, on the one hand, and by their outlets, on the other hand. This makes it possible to implement large battery systems with a correspondingly high power.

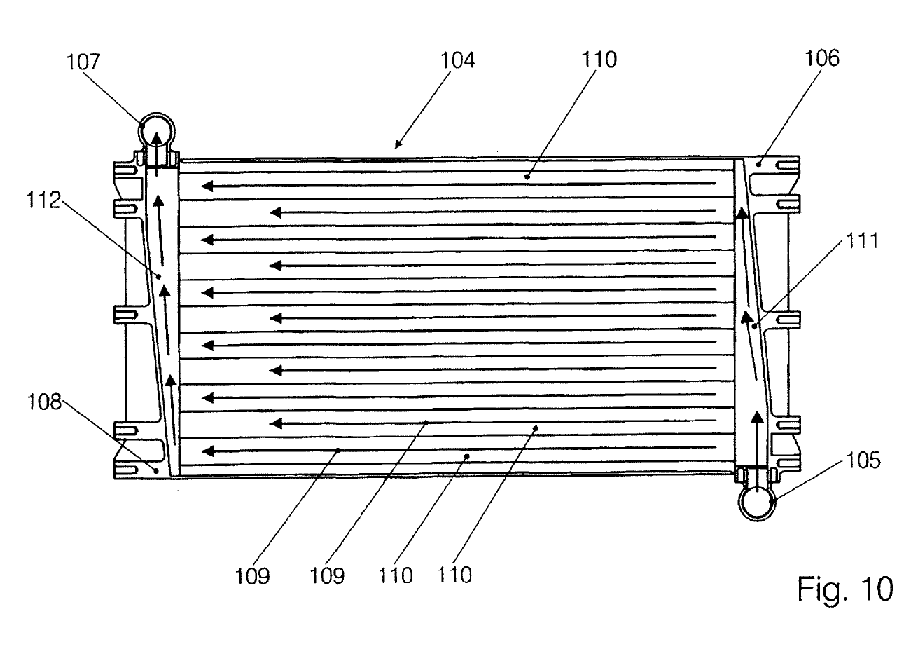

FIG. 10 schematically illustrates another possible refinement of a heat sink 104. In a similar manner to FIG. 7, a vertical longitudinal section of a possible embodiment of a heat sink is likewise illustrated here. This design differs from the other exemplary embodiments shown by virtue of the fact that the inlet 105 is arranged in or on a first covering cap 106 and the outlet 107 is arranged in or on the opposite, second covering cap 108. As can also be seen from FIG. 10, the cooling medium is passed in the same direction through the heat sink 104 in essentially parallel channels 110, as illustrated by arrows 109 for indicating the direction of flow of the cooling medium. So-called distributor and collection spaces 111, 112 are situated in the covering caps 106, 108 in order to distribute the cooling medium from the inlet 105 to the individual channels 110, on one side, and to collect the cooling medium from the channels 110 and guide it to the outlet 107 on the opposite side.

1-21. (canceled)

22. A modular battery unit comprising at least two battery cells and a heat sink arranged between the battery cells and nestles laterally against the battery cells, the heat sink has a cooling medium flowing through it and, on the one hand, removes heat produced in the battery cells in a suitable manner and, on the other hand, supports the battery cells, two covering caps are arranged on the heat sink, a first of the two covering caps closes a first end face of the heat sink and a second of the two covering caps closes a second end face of the heat sink, an inlet and an outlet for the cooling medium for the heat sink, the inlet for the cooling medium being arranged on one of the first and second covering cap and the outlet for the cooling medium being arranged on either of the first and second covering cap.

23. The modular battery unit as claimed in claim 22, wherein the inlet for the cooling medium is arranged on the first covering cap and the outlet for the cooling medium is arranged on the second covering cap.

24. The modular battery unit as claimed in claim 22, wherein both the outlet and the inlet for the cooling medium are arranged on the first covering cap.

25. The modular battery unit as claimed in claim 22, wherein the heat sink has separate channels running in a longitudinal direction of the heat sink between the first and second covering caps, wherein the cooling medium flows through adjacent channels in opposite directions.

26. The modular battery unit as claimed in claim 22, wherein the heat sink has separate channels running in a longitudinal direction of the heat sink between the first and second covering caps, wherein the cooling medium flows through adjacent channels in the same direction.

27. The modular battery unit as claimed in claim 22, wherein the heat sink has separate channels running in a longitudinal direction of the heat sink between the first and second covering caps, the heat sink having two separate regions, wherein the cooling medium flows in adjacent channels in a first direction in a first region of the heat sink and flows in adjacent channels in a second direction, which is opposite the first direction, in a second region.

28. The modular battery unit as claimed in claim 22, wherein a plurality of battery cells are arranged behind one another in the longitudinal direction of the heat sink.

29. The modular battery unit as claimed in claim 22, wherein at least one of the covering caps is in the form of die-cast part and is fastened to the heat sink.

30. The modular battery unit as claimed in claim 25, wherein the heat sink is an extruded part and the adjacent channels in the heat sink are formed by corresponding walls of the extruded profile.

31. The modular battery unit as claimed in claim 30, wherein a connection between two adjacent channels is produced by notches in walls, which notches alternately start from the two end faces of the heat sink.

32. The modular battery unit as claimed in claim 30, wherein the walls of the extruded part profile are tubular and are scaled back in the longitudinal direction of the heat sink in order to connect two adjacent channels of the heat sink.

33. The modular battery unit as claimed in claim 22, wherein the heat sink has recesses in the shape of an arc of a circle for accommodating the battery cells back to back and side by side, and a first profile part which forms a tube and from which intermediate walls start in a star-shaped manner is provided between four respective recesses.

34. The modular battery unit as claimed in claim 33, wherein the covering caps each have a hole in a manner which is congruent with the profile part which forms a tube, with the result that the two covering caps are connected to one another by means of first pulling elements.

35. The modular battery unit as claimed in claim 30, wherein the extruded profile which forms the heat sink has recesses in a shape of an arc of a circle for accommodating cells back to back and side by side, a second profile part which forms a tube and forms three intermediate walls being provided between the two uppermost and lowermost recesses, which are arranged back to back, and a transverse part of the profile.

36. The modular battery unit as claimed in claim 35, wherein the second profile parts which form a tube are flow-connected, on one side, to the inlet or outlet for the coolant.

37. The modular battery unit as claimed in claim 22, including an enclosure for the battery cells and the heat sink, the enclosure comprises outer pulling elements which surround the battery cells on an outer side facing away from the heat sink, a space between the outer pulling elements and parts of the cells which do not rest on the heat sink being filled by a triangular longitudinal profile.

38. The modular battery unit as claimed in claim 37, wherein the triangular longitudinal profile is hollow.

39. A battery system having a plurality of modular battery units, each unit comprising at least two battery cells and a heat sink arranged between the battery cells and nestles laterally against the battery cells, the heat sink has a cooling medium flowing through it and, on the one hand, removes heat produced in the battery cells in a suitable manner and, on the other hand, supports the battery cells, two covering caps are arranged on the heat sink, a first of the two covering caps closes a first end face of the heat sink and a second of the two covering caps closes a second end face of the heat sink, an inlet and an outlet for the cooling medium for the heat sink, the inlet for the cooling medium being arranged on one of the first and second covering cap and the outlet for the cooling medium being arranged on either of the first and second covering cap, the modular battery units being arranged adjacent to one another in a housing, wherein inlets of the battery units are connected to one another and outlets of the battery units being connected to one another.

40. The battery system as claimed in claim 39, wherein each heat sink has a vertical center plane in the longitudinal direction of the heat sink, and the battery units are laterally arranged behind one another in a direction normal to the vertical center planes of the heat sinks.

41. A method for adapting a battery system to an installation space, preferably of a vehicle, the battery system being formed from at least one modular battery unit comprising at least two battery cells and a heat sink arranged between the battery cells and nestles laterally against the battery cells, the heat sink has a cooling medium flowing through it and, on the one hand, removes heat produced in the battery cells in a suitable manner and, on the other hand, supports the battery cells, two covering caps are arranged on the heat sink, a first of the two covering caps closes a first end face of the heat sink and a second of the two covering caps closes a second end face of the heat sink, an inlet and an outlet for the cooling medium for the heat sink, the inlet for the cooling medium being arranged on one of the first and second covering cap and the outlet for the cooling medium being arranged on either of the first and second covering cap, wherein the heat sink of the modular battery unit has a predefined width and height and a variable length, the variable length of the heat sink being selected in a manner corresponding to an installation space length available in the installation space.

42. The method as claimed in claim 41, wherein the heat sink of the modular battery unit is adapted to the selected length from an extruded profile.
